(19) United States
(12) Patent Application Publication
(10) Pub. No.: US 2026/0029572 A1
(43) Pub. Date: Jan. 29, 2026

(54) HIGH-STRENGTH, SMALL DIAMETER FIBER-OPTIC MICROCABLE

(71) Applicant: Sanmina Corporation, San Jose, CA (US)

(72) Inventors: David Ray Porter, Huntsville, AL (US); Robert Alan Conners, Richmond, TX (US)

(21) Appl. No.: 18/784,722

(22) Filed: Jul. 25, 2024

(51) Int. Cl. G02B 6/02; G02B 6/44

(52) U.S. Cl. CPC G02B 6/02395; G02B 6/4431

(57) ABSTRACT

A small diameter microcable is described that is flexible, elastic, high-strength, low-loss, hydrophobic and that does not kink or hockle when twisted or bent. In one example, the optical fiber microcable is a singlemode microcable with a diameter of 750 μm that includes: a core; a cladding; a buffer; a yarn around the buffer; and a jacket formed of Aliphatic Polyketone (APK) around the yarn. The yarn may be formed, e.g., of a liquid crystal polymer (LCP) or may be formed of other suitable materials. In another example, the optical fiber microcable is a singlemode microcable having a diameter of 360 μm that includes: a core; a cladding; a buffer around the cladding; and a jacket formed of APK around the buffer. Methods are also described for fabricating the microcables.

### FIELD

Various features relate to fiber-optic microcables and more specifically to singlemode fiber-optic microcables for undersea applications.

### BACKGROUND

The Fiber Optic Microcable (FOMC) was developed in the early 1980s by the Andrew Corporation for the Naval Command Control Ocean Surveillance Center (NCCOSC) to replace expendable metallic wire tethers employed to communicate with underwater vehicles. The 800-μm (0.031-in.) diameter FOMC technology has found broad application as an expendable tether for unmanned underwater vehicles. The FOMC contains a singlemode optical fiber embedded in a high-modulus, extruded e-glass outer jacket. This microcable was suitable for pre-twisting and winding into an inside-payout cable pack. The cable pack is held together with a binder material and the microcable is pulled out from its center. The microcable is dispensed through an eyelet, straight and without a twist in the microcable. This helps to improve reliability by avoiding kinks and hockles. However, the FOMC can be extremely stiff with a minimum bend radius of approximately 1.5 inches.

Although existing FOMCs have their various advantages and uses, it would still be highly desirable to provide a flexible, elastic, high-strength, low-loss, hydrophobic, small-diameter fiber-optic microcable that does not kink or hockle when twisted or bent.

Herein, such a fiber is described.

### SUMMARY

The following presents a simplified summary of one or more implementations in order to provide a basic understanding of some implementations. This summary is not an extensive overview of all contemplated implementations, and is intended to neither identify key or critical elements of all implementations nor delineate the scope of any or all implementations. Its sole purpose is to present some concepts of one or more implementations in a simplified form as a prelude to the more detailed description that is presented later.

In accordance with some aspects of this disclosure, an optical fiber microcable is provided that includes: a core; a cladding around the core; a buffer around the cladding; a yarn around the buffer; and a jacket around the yarn. The jacket may be formed of Aliphatic Polyketone (APK). The yarn may include, e.g., a liquid crystal polymer (LCP) such as the LCP sold under the trademark Vectran®. In other examples, the yarn may instead include other materials such as the aramid sold under the trademark Kevlar® or the ultra-high-molecular-weight polyethylene (UHMWPE) sold under the trademark Spectra®. The microcable may be, e.g., a singlemode microcable 750 μm in diameter.

In accordance with other aspects of this disclosure, an optical fiber microcable is provided that includes: a core; a cladding around the core; a buffer around the cladding; and a jacket (e.g., formed of APK) around the buffer. That is, the yarn is omitted. The microcable without the yarn may be, e.g., a singlemode microcable 360 μm in diameter.

In accordance with still other aspects of this disclosure, a method for fabricating a microcable is provided. The method includes: providing an optical fiber having a core, a cladding around the core, and a buffer around the cladding; forming a yarn around the buffer; and forming an APK jacket around the yarn.

In accordance with yet other aspects of this disclosure, another method for fabricating a microcable is provided. The method includes: providing an optical fiber having a core, a cladding around the core, and a buffer around the cladding; and extruding APK onto the buffer of the fiber to form a jacket.

In its various aspects, a small diameter microcable is provided that is flexible, clastic, high-strength, low-loss, hydrophobic and that does not kink or hockle when twisted or bent.

These and other aspects of the disclosure will become more fully understood upon a review of the detailed description, which follows. Other aspects, features, and implementations of the disclosure will become apparent to those of ordinary skill in the art, upon reviewing the following description of specific implementations of the disclosure in conjunction with the accompanying figures. While features of the disclosure may be discussed relative to certain implementations and figures below, all implementations of the disclosure can include one or more of the advantageous features discussed herein. In other words, while one or more implementations may be discussed as having certain advantageous features, one or more of such features may also be used in accordance with the various implementations of the disclosure discussed herein. In similar fashion, while certain implementations may be discussed below as device, system, or method implementations, it should be understood that such implementations can be implemented in various devices, systems, and methods.

### BRIEF DESCRIPTION OF THE DRAWINGS

Various features, nature, and advantages may become apparent from the detailed description set forth below when taken in conjunction with the drawings in which like reference characters identify correspondingly throughout.

FIG. 1 is a cross-sectional view of a 750-μm diameter optical fiber microcable configured in accordance with aspects of the disclosure.

FIG. 2 is a cross-sectional view of a 360-μm diameter optical fiber microcable configured in accordance with aspects of the disclosure.

FIG. 3 is a flow diagram summarizing a method for fabricating the 750-μm diameter microcable in accordance with aspects of the disclosure.

FIG. 4 is a flow diagram summarizing a method for fabricating the 360-μm diameter microcable in accordance with aspects of the disclosure.

### DETAILED DESCRIPTION OF THE INVENTION

In the following detailed description, numerous specific details are set forth in order to provide a thorough understanding of the different aspects. However, it will be understood by one of ordinary skill in the art that the different aspects may be practiced without these specific details. For example, well-known operations, structures, and techniques may not be shown in detail in order not to obscure the different aspects presented herein.

Herein, small diameter fiber-optic microcables (or tethers) that do not kink or hockle when twisted or bent are described. The microcables are flexible, elastic, high-strength, low-loss, and hydrophobic. As far as the inventors are aware, no previous fiber-optic microcable design has successfully met all of these desired properties in a singlemode cable design.

In one embodiment, a 750-μm diameter microcable is provided with a bend-insensitive singlemode optical fiber at its center line. A thin layer of Vectran® brand liquid crystal polymer (LCP) yarn is formed around the optical fiber buffer. Alternatively, other materials (e.g., the Kevlar® brand aramid and the Spectra® brand ultra-high-molecular-weight polyethylene (UHMWPE)) may be used as the yarn. The yarn layer helps to isolate the optical fiber from external stresses and helps to insulate the optical fiber during a high-temperature extrusion process. Notably, the yarn is linear. That is, it is not a twisted yarn. It is uniform in the axial direction.

In another embodiment, a 360-μm diameter microcable is provided that omits the yarn. In both embodiments, an outer jacket of Aliphatic Polyketone (APK) is provided.

Either microcable is well-suited for undersea applications, as well as other applications. Other microcable sizes are possible, as well, and other suitable materials may be used.

The outer jacket of APK may be applied in a single high-speed extrusion process. This results in a tight-bound microcable construction where the optical fiber, yarn layer, and APK jacket share the tensile load, maximizing tensile strength. Aliphatic carbon are small fragments of graphene terminated around its perimeter with hydrogen atoms. Aliphatic carbon is more readily available and affordable than larger pieces of graphene. Note that graphene formed from the element carbon is the strongest known material. It is capable of maintaining its tensile strength at 4 percent elongation. This combination of high strength and elasticity in the APK jacket and the glass optical fiber provides the ideal combination to achieve an ultra-high-strength fiber-optic microcable. At 4 percent elongation, a glass optical fiber has a mechanical stress of 400 kilopounds per square inch (kpsi). A standard commercial optical fiber is typically proof tested at 200 kpsi; however, the preferred fiber manufacturer claims that almost all of the fiber coming off of its draw towers exceeds 600-650 kpsi. The intrinsic breaking strength of the glass optical fiber is over 900 kpsi. Although APK is preferred, other suitable materials may be used to form the jacket such as polyether ether ketone (PEEK).

As an example, the working strength of one prototype embodiment of a 750-μm microcable was greater than 35 pounds and the breaking strength was over 60 pounds. The operating temperature range exceeds the −55° C. to +125° C. range, typically specified for military and aerospace applications. Furthermore, the cable design is symmetrical about its centerline. This is important for achieving a low optical attenuation, i.e., less than 0.25 dB/km at 1550 nm. This is also important for maintaining a low optical loss under high hydrostatic pressures, e.g., deep sea applications.

For applications requiring the smaller microcable (e.g., the 360-μm microcable), the APK jacket may be extruded directly over the optical fiber buffer, without the yarn layer. The smaller size is desirable for extended-range applications where exceptionally high tensile strength is not required, but where additional stiffness and abrasion resistance is desired. The specific gravity of the microcable is greater than 1; i.e., it sinks in water and may reach the sea floor before completing its mission. The sea floor is highly diverse in its topology and habitation of marine biologics. The microcable will eventually break after a period of time when the microcable reaches the seafloor. For example, it may break when it is pulled taut over a sharp edge, abraded over a rough surface, or attacked by a marine species. However, the addition of a thin APK jacket will extend the time to breakage because it is stronger, stiffer, more cut resistant, and more abrasion resistant.

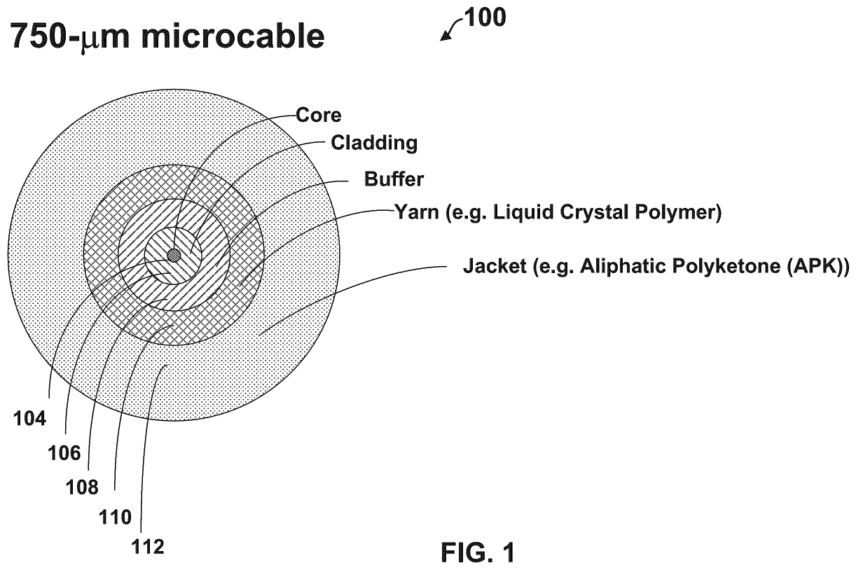

FIG. 1 is a cross-sectional view of a 750-μm optical fiber microcable 100 that includes a yarn layer. The 750-μm microcable 100 includes: a core 104, a cladding 106 surrounding the core 104, and a buffer 108 (or buffer coating) surrounding the cladding 106. The buffer 108 may be a dual modulus buffer, i.e., a buffer having an inner portion with a first Young's modulus and an outer portion with a different Young's modulus. However, a single modulus buffer may be used as well. The core 104, cladding 106, and buffer 108 may be formed of conventional optical fiber materials. For example, the core may be formed of fused silica, glass, or plastic, the cladding may be a silica or a polymer, and the buffer may be formed of materials such as polyvinylidene fluoride (Kynar®), polytetrafluoroethylene (Teflon™), or polyurethane. The core, cladding, and buffer may form a 250-μm optic fiber (or, in other examples, a 200-μm optic fiber).

A yarn 110 is formed around the buffer 108. The yarn 110 may be an LCP such as the LCP sold under the trademark Vectran® by Kuraray Co., Ltd. Vectran® is an aromatic polyester produced by the polycondensation of 4-hydroxybenzoic acid and 6-hydroxynaphthalene-2-carboxylic acid. In other examples, the yarn may be formed from the aramid sold under the trademark Kevlar® by DuPont de Nemours, Inc., which may be described as poly (azanediyl-1,4-phenyleneazanediylterephthaloyl). In other examples, the yarn may be formed from the UHMWPE sold under the trademark Spectra® by Honeywell Inc. A jacket 112 surrounds the yarn 110. The jacket is formed of APK. Thus, microcable 100 may be described as a symmetrical optical fiber microcable in which a yarn is positioned between the buffer and the jacket of the microcable and in which the jacket is formed of APK. Alternatively, rather than using APK, PEEK or other suitable materials might be used. For example, a PEEK jacket may be formed over an LCP yarn.

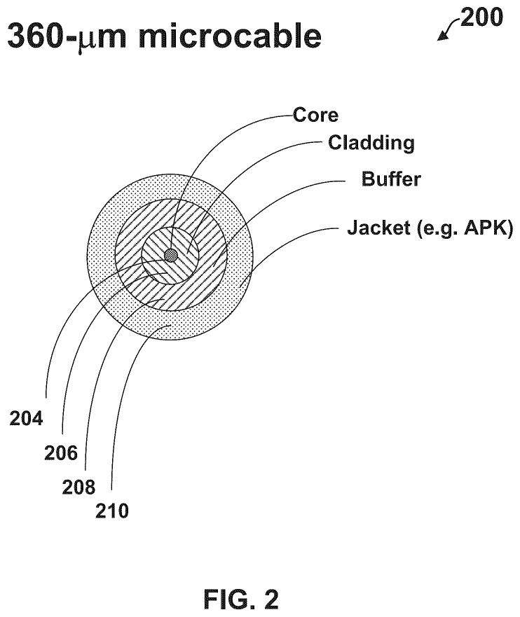

FIG. 2 is a cross-sectional view of a 360-μm optical fiber microcable 200 that is similar to the microcable of FIG. 1 but omits the yarn layer. The 360-μm microcable 200 includes: a core 204, a cladding 206 surrounding the core 204, and a buffer 208 surrounding the cladding 206. The core 204, cladding 206, and buffer 208 may be formed of conventional optical fiber materials such as the materials noted above. A jacket 210 surrounds the buffer 208. The jacket is formed of APK. Thus, microcable 102 may be described as a symmetrical optical fiber microcable in which the jacket is formed of APK.

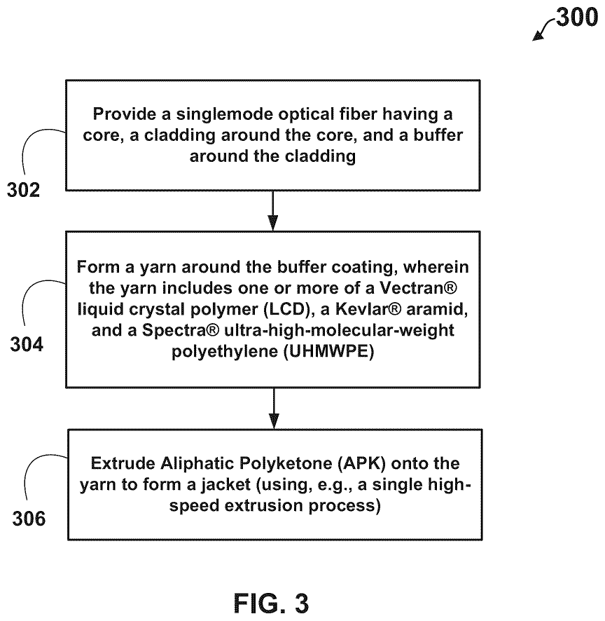

FIG. 3 summarizes a method 300 for fabricating the microcable 100 of FIG. 1. Briefly, at block 302, a singlemode optical fiber is provided having a core, a cladding around the core, and a buffer around the cladding. At block 304, a yarn is formed around the buffer, wherein the yarn includes one or more of a Vectran® LCD, a Kevlar® aramid, and a Spectra® UHMWPE. At block 306, APK is extruded onto the yarn to form a jacket.

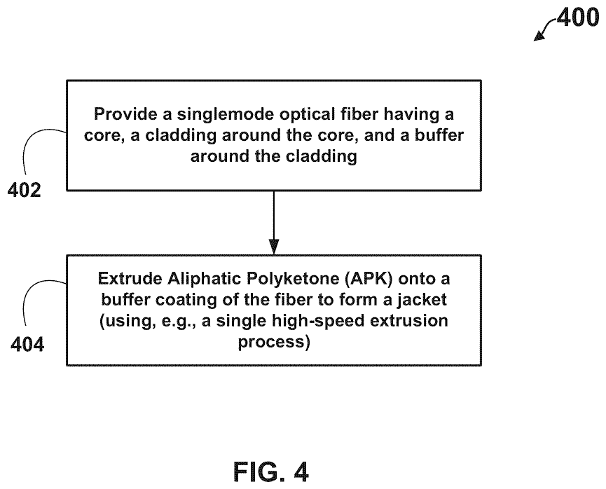

FIG. 4 summarizes a method 400 for fabricating the microcable 200 of FIG. 2. Briefly, at block 402, a singlemode optical fiber is provided having a core, a cladding around the core, and a buffer around the cladding. At block 404, APK is extruded onto the yarn to form a jacket.

While certain exemplary embodiments have been described and shown in the accompanying drawings, such embodiments are merely illustrative of and not restrictive on the broad invention, and this invention is not limited to the specific constructions and arrangements shown and described, since various other modifications may occur to those ordinarily skilled in the art.

1. An optical fiber microcable, comprising:
a core;
a cladding around the core;
a buffer around the cladding;
a yarn around the buffer; and
a jacket formed of Aliphatic Polyketone (APK) around the yarn.

2. The microcable of claim 1, wherein the microcable is a singlemode microcable.

3. The microcable of claim 1, wherein the yarn comprises a liquid crystal polymer.

4. The microcable of claim 3, wherein the liquid crystal polymer of the yarn comprises an aromatic polyester produced by the polycondensation of 4-hydroxybenzoic acid and 6-hydroxynaphthalene-2-carboxylic acid.

5. The microcable of claim 1, wherein the yarn comprises an aramid including poly(azanediyl-1,4-phenyleneazanediylterephthaloyl).

6. The microcable of claim 1, wherein the yarn comprises an ultra-high-molecular-weight polyethylene (UHMWPE).

7. The microcable of claim 1, wherein the microcable has a diameter of 750 μm.

8. A method for fabricating a microcable, the method comprising:
providing an optical fiber having a core, a cladding around the core, and a buffer around the cladding;
forming a yarn around the buffer; and
forming a jacket of Aliphatic Polyketone (APK) around the yarn.

9. The method of claim 8, wherein forming the APK jacket on the yarn comprises extruding the APK onto the yarn.

10. The method of claim 8, wherein the yarn comprises a liquid crystal polymer.

11. The method of claim 10, wherein the liquid crystal polymer of the yarn comprises an aromatic polyester produced by the polycondensation of 4-hydroxybenzoic acid and 6-hydroxynaphthalene-2-carboxylic acid.

12. The method of claim 8, wherein the yarn comprises an aramid including poly(azanediyl-1,4-phenyleneazanediylterephthaloyl).

13. The method of claim 8, wherein the yarn comprises an ultra-high-molecular-weight polyethylene (UHMWPE).

14. The method of claim 8, wherein the microcable is formed to have a diameter of 750 μm.

15. An optical fiber microcable comprising:
a core;
a cladding around the core;
a buffer around the cladding; and
a jacket formed of Aliphatic Polyketone (APK) around the buffer.

16. The microcable of claim 15, wherein the microcable is a singlemode microcable.

17. The microcable of claim 15, wherein the microcable has a diameter of 360 μm.

18. A method for fabricating a microcable, the method comprising:
providing an optical fiber having a core, a cladding around the core, and a buffer around the cladding; and
extruding Aliphatic Polyketone (APK) onto the buffer to form a jacket.

19. The method of claim 18, wherein the APK is applied in a single extrusion process.
